(19) United States
(12) Patent Application Publication
(10) Pub. No.: US 2017/0210119 A1
(43) Pub. Date: Jul. 27, 2017

(54) PUNCHING MECHANISM AND SHEET PROCESSING APPARATUS

(71) Applicants: KABUSHIKI KAISHA TOSHIBA, Tokyo (JP); TOSHIBA TEC KABUSHIKI KAISHA, Tokyo (JP)

(72) Inventor: Katsuya Sasahara, Izu Shizuoka (JP)

(21) Appl. No.: 15/002,605

(22) Filed: Jan. 21, 2016

(51) Int. Cl. B41F 23/00; B26F 1/14

(52) U.S. Cl. CPC B41F 23/00; B26F 1/14

(57) ABSTRACT

A punching mechanism comprises a punching member, a drive section and a reciprocation assisting section. The punching member punches a hole in a sheet. The drive section causes the punching member to reciprocate with respect to the sheet. The reciprocation assisting section stores part of the energy generated from the reciprocation of the punching member and the driving of the drive section during the period the punching member starts reciprocating from an initial position and returns to the initial position. The reciprocation assisting section outputs the stored energy as an auxiliary force used for assisting the punching member in the next reciprocation.

### FIELD

Embodiments described herein relate generally to a punching mechanism and a sheet processing apparatus.

### BACKGROUND

A post-processing apparatus is known which carries out a post-processing for a sheet conveyed from an image forming apparatus. The post-processing apparatus comprises a discharging section and a punching mechanism. The discharging section discharges a sheet conveyed from a conveyance path. The punching mechanism punches a hole in a sheet when the sheet is being conveyed towards the discharging section. The punching mechanism comprises, in the direction of the normal line of the sheet, a drive section for causing a punching member to reciprocate. For example, the drive section causes the punching member to reciprocate through the clockwise rotation and the anticlockwise rotation of a direct-current motor.

Further, it is desired to convey a punched sheet to the discharging section smoothly in the post-processing apparatus. To convey a punched sheet smoothly, a conveyance path should be provided rapidly for the sheet. To provide a conveyance path rapidly for a sheet, it is needed to lower the punching member quickly to punch a hole in a sheet and then lift and stop the punching member quickly. As a method for speeding up or down the punching member quickly, a motor is rotated clockwise and anticlockwise rapidly. However, if a motor is rotated clockwise and anticlockwise rapidly, it is possible that a problem such as the increase of a peak current may occur. Further, if a motor is rotated anticlockwise rapidly, then the energy resulting from the rapid clockwise rotation of the motor is lost, leading to problems such as energy inefficiency. Particularly, if a motor is repeatedly rotated clockwise and anticlockwise rapidly, then problems such as severe energy inefficiency may occur. As a consequence, more energy is consumed because of increased peak current and inefficient energy.

### DESCRIPTION OF THE DRAWINGS

FIG. 1 is a front view exemplifying the whole structure of an image forming system according to an embodiment;

FIG. 2 is a block diagram exemplifying the whole structure of an image forming system according to an embodiment;

FIG. 3 is an oblique view of a punching mechanism according to an embodiment;

FIG. 4 shows a section of the punching mechanism shown in FIG. 3 taken along the line IV shown in FIG. 3;

FIG. 5 is a schematic diagram illustrating the peripherals of the punching mechanism shown in FIG. 3 and including a section of the punching mechanism shown in FIG. 3 taken along the line V shown in FIG. 3;

FIG. 6 is a schematic diagram illustrating the reciprocation assisting section of a punching member according to an embodiment;

FIG. 7 is a diagram illustrating an upper dead point position of a punching member according to an embodiment;

FIG. 8 is a diagram illustrating the position of a punching member moving from an upper dead point position and a lower dead point position according to an embodiment;

FIG. 9 is a diagram illustrating the lower dead point position of a punching member according to an embodiment;

FIG. 10 is a diagram illustrating the position of a punching member moving from the lower dead point to the upper dead point according to an embodiment;

FIG. 11 is a circuit diagram exemplifying the electric connection of a motor according to an embodiment;

FIG. 12 is a diagram illustrating the effect of a reciprocation assisting section according to an embodiment;

FIG. 13 is a diagram exemplifying a modification of a reciprocation assisting section according to an embodiment; and

FIG. 14 is a diagram exemplifying a modification of embodiments of a drive section according to an embodiment.

### DETAILED DESCRIPTION

In accordance with an embodiment, a punching mechanism comprises a punching member, a drive section and a reciprocation assisting section. The punching member punches a hole in a sheet. The drive section causes the punching member to reciprocate with respect to the sheet. The reciprocation assisting section stores part of the energy generated from the reciprocation of the punching member and the driving of the drive section during the period the punching member starts reciprocating from an initial position and returns to the initial position. The reciprocation assisting section outputs the stored energy as an auxiliary force used for assisting the punching member in the next reciprocation.

Embodiments of a sheet processing apparatus are described below with reference to accompanying drawings in which identical members are denoted by identical reference signs.

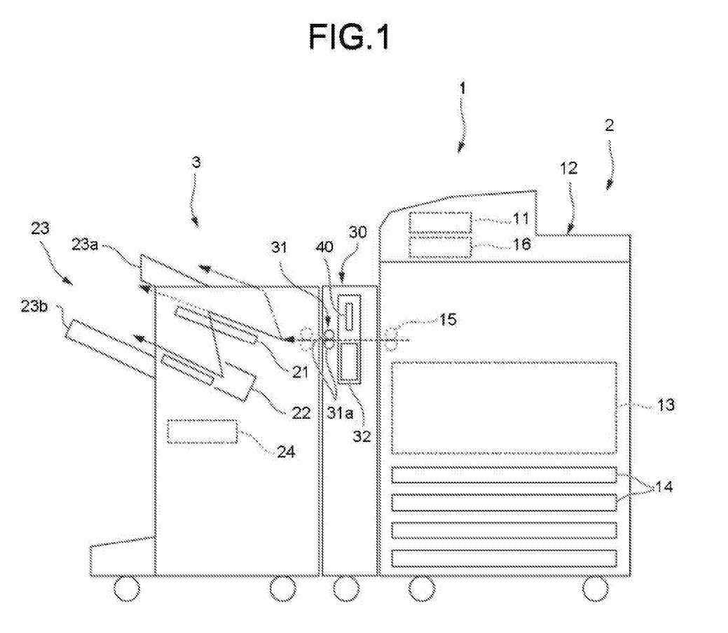

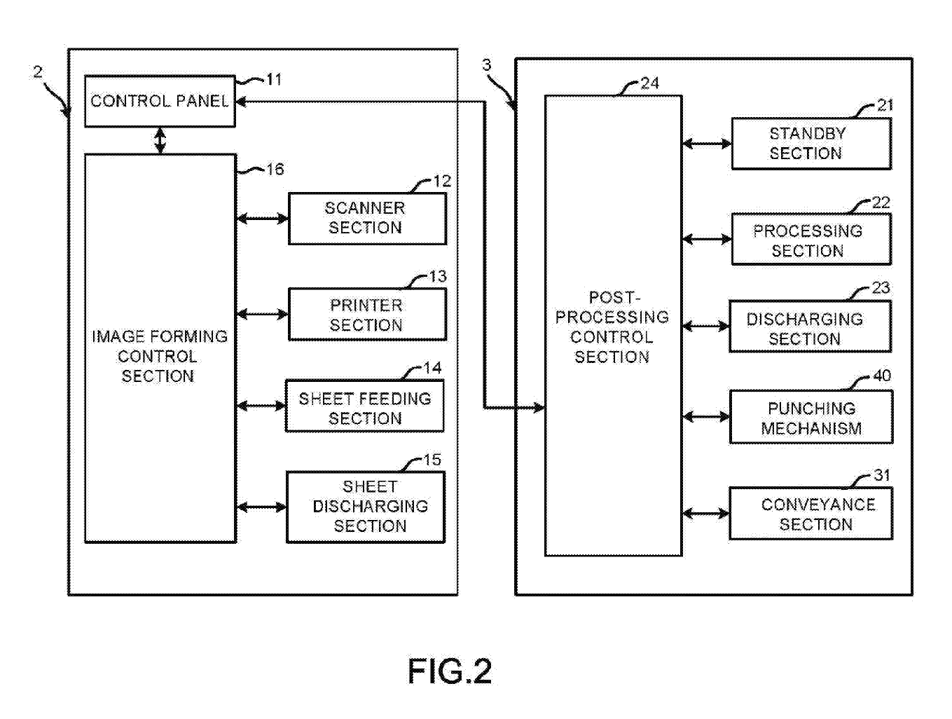

FIG. 1 and FIG. 2 exemplify the whole structure of an image forming system 1 according to an embodiment. As shown in FIG. 1 and FIG. 2, an image forming system 1 comprises an image forming apparatus 2 and a post-processing apparatus 3.

The image forming apparatus 2 forms an image on a sheet-like medium (hereinafter referred to as a ‘sheet’) such as paper. The image forming apparatus 2 comprises a control panel 11, a scanner section 12, a printer section 13, a sheet feeding section 14, a sheet discharging section 15 and an image forming control section 16.

The control panel 11 is equipped with various keys to receive an operation of a user. For example, the control panel 11 receives an input relating to the category of a post-processing to be executed on a sheet. The control panel 11 sends information relating to the input category of a post-processing to be executed on a sheet to the post-processing apparatus 3.

The scanner section 12 comprises a reading section for reading the image information of a copied object. The scanner section 12 sends the read image information to the printer section 13.

The printer section 13 forms an output image (hereinafter referred to as a toner image) with a developing agent such as a toner according to the image information sent from the scanner section 12 or an external machine. The printer section 13 transfers the toner image onto the surface of a sheet. The printer section 13 applies heat and pressure to the toner image transferred on the surface of the sheet to fix the toner image on the sheet.

The sheet feeding section 14 feeds sheets, one by one, to the printer section 13 at the timing of the formation of toner images by the printer section 13.

The sheet discharging section 15 conveys a sheet discharged from the printer section 13 to the post-processing apparatus 3.

The image forming control section 16 controls the whole operation of the image forming apparatus 2. That is, the image forming control section 16 controls the control panel 11, the scanner section 12, the printer section 13, the sheet feeding section 14 and the sheet discharging section 15. The image forming control section 16 consists of a control circuit including a CPU, a ROM and a RAM.

Next, the post-processing apparatus 3 is described below.

The post-processing apparatus 3 is an example of ‘a sheet processing apparatus’. The post-processing apparatus 3 is arranged adjacent to the image forming apparatus 2. The post-processing apparatus 3 carries out a post-processing designated through the control panel 11 for a sheet conveyed from the image forming apparatus 2. The post-processing apparatus 3 comprises a punching processing section 30, a standby section 21, a processing section 22, a discharging section 23 and a post-processing control section 24.

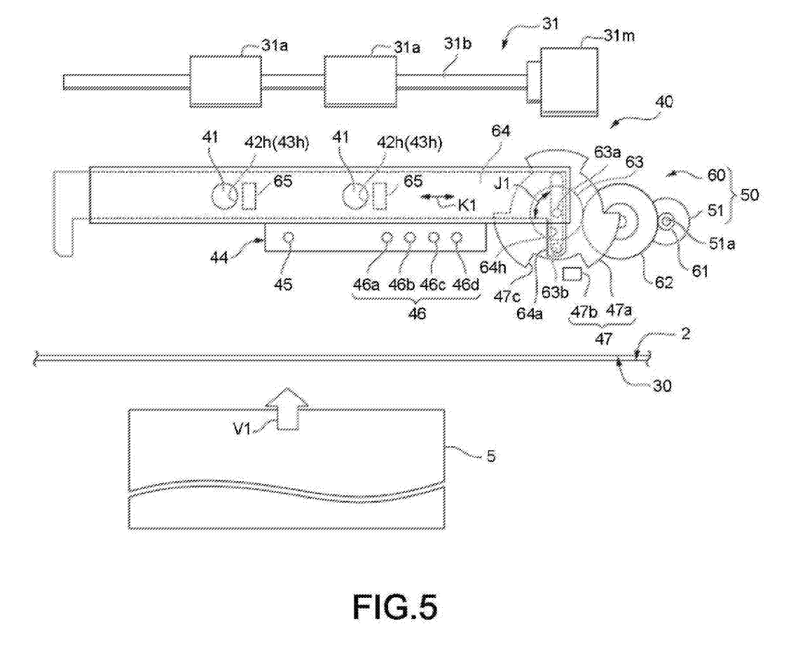

The punching processing section 30 which carries out a punching processing for a sheet 5 (refer to FIG. 5) comprises a punching mechanism 40, a conveyance section 31 and a dust box 32.

The conveyance section 31 conveys the sheet 5 conveyed from the image forming apparatus 2 towards the standby section 21. The conveyance section 31 comprises a pair of rollers 31a. As shown in FIG. 5, the rollers 31a are mounted on a shaft 31b. A plurality of rollers 31a (two, in the embodiment) are arranged along the direction of a shaft 31b. A transmission motor 31m is arranged on one end section of the shaft 31b. The roller 31a and the shaft 31b are rotationally driven together by the transmission motor 31m. Generally, the rotary drive based on the transmission motor 31m is slowed down by a pulley belt gear (not shown). FIG. 5 simply illustrates the structure of the conveyance section 31.

As shown in FIG. 1, the dust box 32 is arranged under the punching mechanism 40 described later. The scraps generated from a punching processing fall into and are collected in the dust box 32.

The standby section 21 temporarily retains (buffers) the sheet 5 conveyed from the punching processing section 30. For example, the standby section 21 keeps following sheets 5 waiting during the period the processing section 22 carries out a post-processing for the current sheet 5. If the processing section 22 idles, the standby section 21 makes a retained sheet 5 fall into the processing section 22. The processing section 22 carries out a post-processing for the sheet 5. The post-processing refers to a staple processing or a sorting processing. For example, the processing section 22 aligns a plurality of sheets 5. The processing section 22 carries out a staple processing for the plurality of aligned sheets 5. The plurality of sheets 5 is stapled through a staple processing. The processing section 22 discharges the sheet 5 subjected to the post-processing to the discharging section 23.

The discharging section 23 comprises a fixed tray 23a and a movable tray 23b. The fixed tray 23a is arranged on the upper part of the post-processing apparatus 3. The movable tray 23b is arranged on a lateral side of the post-processing apparatus 3. The sorted sheets 5 are discharged into the movable tray 23b.

The post-processing control section 24 controls the whole operation of the post-processing apparatus 3. As shown in FIG. 2, the post-processing control section 24 controls the standby section 21, the processing section 22, the discharging section 23, the punching mechanism 40 and the conveyance section 31. For example, the post-processing control section 24 consists of a control circuit including a CPU, a ROM and a RAM.

Next, the punching mechanism 40 is described.

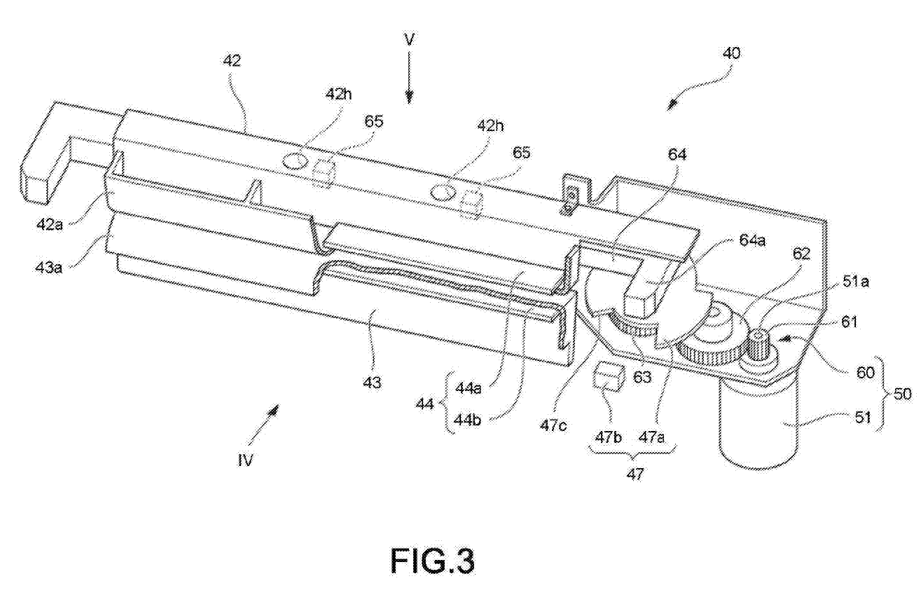

The punching mechanism 40 punches a hole in a sheet 5 when the sheet 5 is being conveyed towards the discharging section 23. As shown in FIG. 3-FIG. 6, the punching mechanism 40 comprises a punching member 41, a support member 42, a receiving member 43, a sheet detection section 44, a drive section 50, a rotation position detection section 47 and a reciprocation assisting section 70.

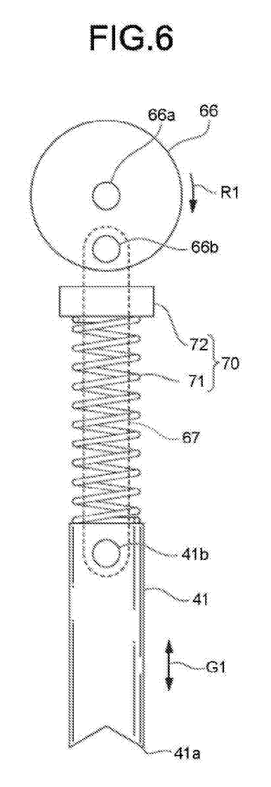

The punching member 41 punches a hole in a sheet 5. For example, the punching member 41 is a punch head (punch knife). The direction of the normal line of the sheet 5 is the perpendicular direction. As shown in FIG. 6, the punching member 41 comprises an extender in the perpendicular direction. A blade 41a of the punching member 41 is located at the lower end of the punching member 41. A plurality of punching members 41 (two, in the embodiment) are arranged in the width direction of the sheet 5 (hereinafter referred to as a ‘sheet width direction’) orthogonal to a sheet conveyance direction V1 (refer to FIG. 5).

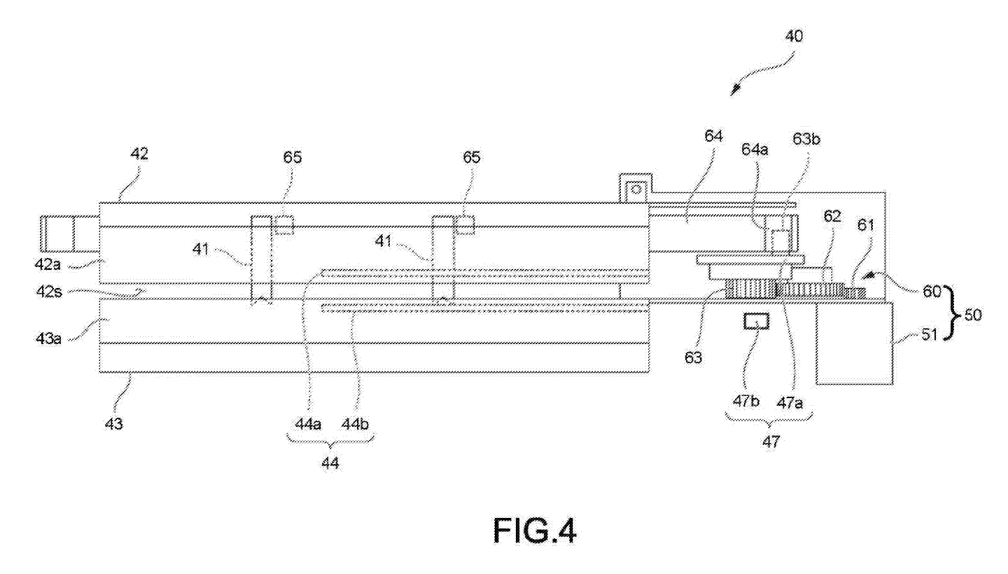

As shown in FIG. 3 and FIG. 4, the support member 42 supports the punching member 41. The support member 42 is provided with an extender in the sheet width direction. A first through hole 42h penetrating the support member 42 in the perpendicular direction is formed on the support member 42. A plurality of first through holes 42h (two, in the embodiment) are arranged in the sheet width direction. The punching members 41 are inserted into each first through hole 42h. A first guide member 42a is mounted on the support member 42 to guide the conveyance of the sheet 5.

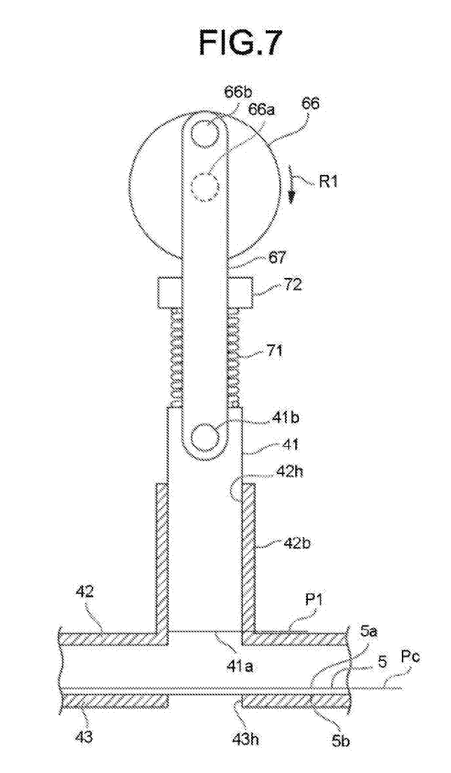

As shown in FIG. 7, a guide wall 42b for guiding the reciprocation of the punching member 41 is formed on the support member 42. The guide wall 42b is formed into a cylinder in which the first through hole 42h is formed. The direction in which the punching member 41 reciprocates refers to the perpendicular direction.

As shown in FIG. 3 and FIG. 4, the receiving member 43 is arranged under and opposite to the support member 42 with a gap 42s formed therebetween. The width of the gap 42s is greater than the thickness of the conveyed sheet 5. The receiving member 43 is provided with an extender in the sheet width direction. In the sheet width direction, the receiving member 43 is substantially as long as the support member 42. A second through hole 43h penetrating the receiving member 43 in the perpendicular direction is formed on the receiving member 43. A plurality of second through holes 43h (two, in the embodiment) are arranged in the sheet width direction. Each second through hole 43h is arranged opposite to one first through hole 42h. The blade 41a of the punching member 41 is inserted into the second through hole 43h during a punching processing. A second guide member 43a is mounted on the receiving member 43 to guide the conveyance of the sheet 5.

The sheet detection section 44 comprises a light emitting section 44a and a light receiving section 44b. The light emitting section 44a is located opposite to the light receiving section 44b across the first guide member 42a and the second guide member 43a. The sheet detection section 44 detects a sheet 5 by causing the sheet 5 to pass through the part between the light emitting section 44a and the light receiving section 44b.

As shown in FIG. 5, the sheet detection section 44 comprises a first detection section 45 and a second detection section 46. The first detection section 45 detects the front end (a downstream end) and the rear end (an upstream end) of a sheet 5 in the sheet conveyance direction V1. The second detection section 46 detects the ends of the sheet 5 (the ends of the sheet in the sheet width direction) that is conveyed along the sheet conveyance direction V1. The second detection section 46 comprises a plurality of sensors 46a-46d (a first sensor 46a, a second sensor 46b, a third sensor 46c and a fourth sensor 46d) corresponding to a plurality of sheet sizes (four, in the present embodiment). The first sensor 46a, the second sensor 46b, the third sensor 46c and the fourth sensor 46d are arranged along the sheet width direction. For example, the first sensor 46a corresponds to a sheet size B5-R. For example, the second sensor 46b corresponds to a sheet size A4-R. For example, the third sensor 46c corresponds to sheet sizes B5, B4, 16K and 8K. For example, the fourth sensor 46d corresponds to sheet sizes A4 and A3.

The drive section 50 comprises a motor 51 and a power transmission mechanism 60.

For example, the motor 51 is a direct-current motor. The power transmission mechanism 60 transfers the driving force of the motor 51 to the punching member 41 for the execution of a punching operation. The power transmission mechanism 60 comprises a first gear 61, a second gear 62, a third gear 63, a suspension member 64, a power conversion section 65, a rotating member 66 and an arm section 67.

The first gear 61 and an output shaft 51a of the motor are arranged coaxially. The second gear 62 is meshed with the first gear 61. The third gear 63 is rotationally driven by the second gear 62 around a center shaft 63a parallel to the output shaft 51a. A transmission shaft 63b is arranged on the third gear 63 at a position which is deviated towards the outside from the center shaft 63a in the axial direction of the third gear 63.

The suspension member 64 is provided with an extender in the sheet width direction. An extension section 64a is arranged on one end of the suspension member 64. A long hole 64h into which the transmission shaft 63b of the third gear 63 is inserted is formed on the extension section 64a. Thus, if the motor 51 is rotated, then the third gear 63 is rotated along the direction indicated by the arrow J1. Consequentially, the transmission shaft 63b of the third gear 63 moves along the long hole 64h of the extension section 64a. Then, the suspension member 64 moves, under the guidance of the support member 42, in the direction indicated by the arrow K1 which is parallel to the sheet width direction.

The power conversion section 65 converts the movement of the suspension member 64 in the direction indicated by the arrow K1 into the rotation around a center shaft 66a of the rotating member 66. A transmission shaft 66b is arranged on the rotating member 6 at a position which is deviated towards the outside from the center shaft 66a in the axial direction of the third gear 63. The arm section 67 comprises an extender in the perpendicular direction. The upper end of the arm section 67 is mounted on the transmission shaft 66b of the rotating member 66 in a rotatable manner. A support shaft 41b is arranged on the upper end of the punching member 41. The lower end of the arm section 67 is mounted on the support shaft 41b in a rotatable manner. Thus, if the rotating member 66 is rotated along the direction indicated by an arrow R1, then the punching member 41 reciprocates along the perpendicular direction (the direction indicated by an arrow G1).

The rotation position detection section 47 comprises a light shielding member 47a and an optical sensor 47b. The light shielding member 47a is mounted on the upper surface of the third gear 63. The optical sensor 47b is arranged nearby the light shielding member 47a. The optical sensor 47b detects the position of the light shielding member 47a by emitting light towards the light shielding member 47a.

The third gear 63 and the light shielding member 47a rotate together with the rotation of the motor 51. The third gear 63 and the light shielding member 47a rotate clockwise and anticlockwise according to the rotation of the motor 51. The light shielding member 47a shields the light from the optical sensor 47b according to the rotation of the motor 51. Or the light shielding member 47a fails to shield the light from the optical sensor 47b according to the rotation of the motor 51. Specifically, the light from the optical sensor 47b passes through a notch section 47c of the light shielding member 47a according to the rotation of the motor 51.

For example, the optical sensor 47b detects a signal representing the pass of light through the notch section 47c as a bright signal. The optical sensor 47b detects a signal representing the shielding of light by the light shielding member 47a as a dark signal. According to the bright signal and the dark signal, the optical sensor 47b detects the rotation position of the third gear 63.

The third gear 63 rotates clockwise and anticlockwise according to the rotation of the motor 51 so that the punching member 41 reciprocates in the perpendicular direction. Thus, by detecting the rotation position of the third gear 63, the position of the blade 41a of the punching member 41 is known.

The reciprocation assisting section 70 stores part of the energy generated from the reciprocation of the punching member 41 and the driving of the drive section 50 during the period the punching member 41 starts reciprocating from an initial position and returns to the initial position. The reciprocation assisting section outputs the stored energy as an auxiliary force used for assisting the punching member 41 in the next reciprocation. As shown in FIG. 6, the reciprocation assisting section 70 comprises a spring 71 and a spring support section 72.

The spring 71 extends and retracts in the perpendicular direction. The spring 71 is a helical compression spring (compression spring). The spring support section 72 is arranged on the spring 71. The punching member 41 is arranged under the spring 71. The upper end portion of the spring 71 is supported by the spring support section 72. The lower end portion of the spring 71 is not connected with the punching member 41. The spring 71 can be detached from the punching member 41. The spring 71 and the punching member 41 are arranged independent from each other. The lower end of the spring 71 in a free state is connected with the upper end of the punching member 41.

The position of the punching member 41 is described below.

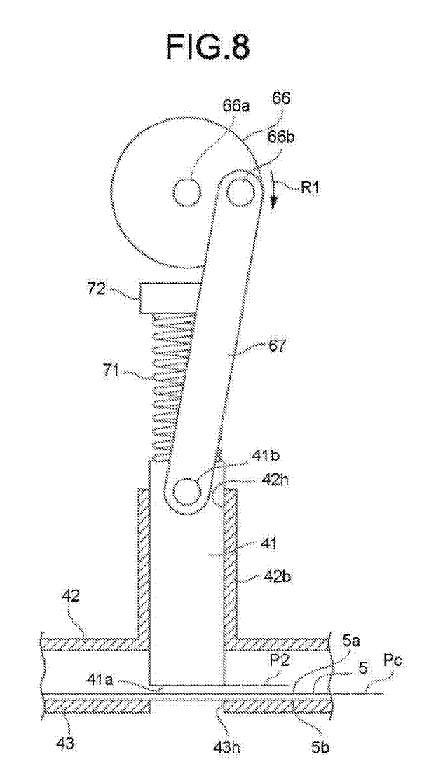

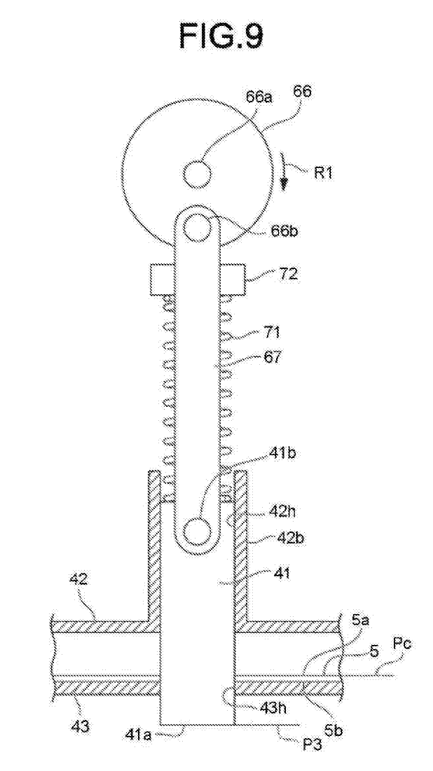

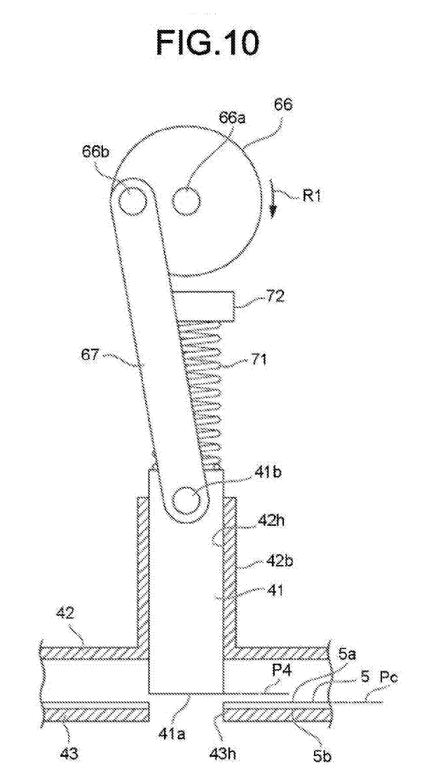

FIG. 7 shows an upper dead point position (the initial position) P1 of the punching member 41. FIG. 8 shows the position (hereinafter referred to as a ‘first intermediate position P2’) of the punching member 41 moving from the upper dead point position P1 to a lower dead point position P3. FIG. 9 shows the lower dead point position P3 of the punching member 41. FIG. 10 shows the position (hereinafter referred to as a ‘second intermediate position P4’) of the punching member 41 moving from the lower dead point position P3 to the upper dead point position P1.

As shown in FIG. 7, the upper dead point position P1 is the position of the punching member 41 when the punching member 41 locates at the highest position in the reciprocation range thereof. The blade 41a of the punching member 41 is above the sheet 5 at the upper dead point position P1. At the upper dead point position P1, the blade 41a of the punching member 41 is surrounded by guide walls 42b.

As shown in FIG. 9, the lower dead point position P3 is the position of the punching member 41 when the punching member 41 locates at the highest position in the reciprocation range thereof. At the lower dead point position P3, the blade 41a of the punching member 41 is under the sheet 5. At the lower dead point position P3, the blade 41a of the punching member 41 protrudes downwards with respect to the receiving member 43.

As shown in FIG. 7 and FIG. 9, the arm section 67 and the punching member 41 are both perpendicular at the upper dead point position P1 and the lower dead point position P3. As shown in FIG. 8 and FIG. 10, the arm section 67 is inclined with respect to the perpendicular direction at the first intermediate position P2 and the second intermediate position P4.

The operations of the punching member 40 are described below.

As shown in FIG. 7-FIG. 10, the punching member 41 reciprocates between the upper dead point position P1 and the lower dead point position P3. Specifically, the punching member 41 reciprocates sequentially from the upper dead point position P1, sequentially through the first intermediate position P2 and the lower dead point position P3 and to the second intermediate position P4 as the rotating member 66 is rotated in the direction indicated by the arrow R1.

As shown in FIG. 7, the spring 71 is compressed in the perpendicular direction when the punching member 41 is at the upper dead point position P1. An unpunched sheet 5 is placed under the punching member 41 when the punching member 41 is at the upper dead point position P1. The spring 71 stores a force (hereinafter referred to as a spring force) for assisting the punching member 41 in punching a hole in the sheet 5 as the foregoing auxiliary force when the punching member 41 is at the upper dead point position P1. The spring 71 stores the spring force when the punching member 41 moves from the lower dead point position P3 to the upper dead point position P1. The punching member 41 at the upper dead point position P1 moves towards the first intermediate position P2 (refer to FIG. 8) as the rotating member 66 is rotated in the direction indicated by the arrow R1.

As shown in FIG. 8, the punching member 41 at the first intermediate position P2 is lowered towards the sheet 5 as the rotating member 66 is rotated in the direction indicated by the arrow R1. The spring 71 outputs the stored spring force while the punching member 41 is at the first intermediate position P2. The spring 71 outputs the stored spring force during the period the punching member 41 moves from the upper dead point position P1 to the lower dead point position P3. The spring 71 outputs the stored spring force during the period the blade 41a of the punching member 41 moves from the upper dead point position P1 to a position (hereinafter referred to as a ‘punching position Pc’) where the blade 41a is connected with a first surface 5a at the upper side of the sheet 5. For example, the spring 71 is in a free state when the blade 41a of the punching member 41 is at the punching position Pc. The punching member 41 at the first intermediate position P2 moves towards the lower dead point position P3 (refer to FIG. 9) if the rotating member 66 is rotated in the direction indicated by the arrow R1.

As shown in FIG. 9, the punching member 41 punches a hole in a sheet 5 by means of the driving force of the drive section 50 and the spring force of the spring 71. The descending speed of the punching member 41 reaches the maximum when the punching member 41 punches a hole in the sheet 5 (when the blade 41a of the punching member 41 reaches the punching position Pc). A hole is punched in the sheet 5 if the punching member 41 passes through a second surface 5b at the lower side (the side opposite to the first surface 5a) of the sheet 5. A force for assisting the punching member 41 finishing punching a hole in the sheet 5 in returning to the punching position Pc (ascending towards the punching position Pc) from the lower dead point position P3 is hereinafter referred to as a ‘return assisting force’. The reciprocation assisting section 70 stores the return assisting force as an auxiliary force during the period the punching member 41 moves from the punching position Pc to the lower dead point position P3. The punching member 41 at the lower dead point position P3 moves towards the second intermediate position P4 (refer to FIG. 10) as the rotating member 66 is rotated in the direction indicated by the arrow R1.

As shown in FIG. 10, the punching member 41 at the second intermediate position P4 ascends towards the upper dead point position P1 as the rotating member 66 is rotated in the direction indicated by the arrow R1. For example, even if the motor 51 stops rotating after a sheet is punched, the punching member 41 at the second intermediate position P4 ascends naturally towards the upper dead point position P1 under the rotational inertia force of the rotating member 66. The spring 71 is compressed according to the ascending of the punching member 41. The spring 71 stores the kinetic energy generated by the ascending of the punching member 41 as a spring force which is used later to punch a hole in the sheet 5.

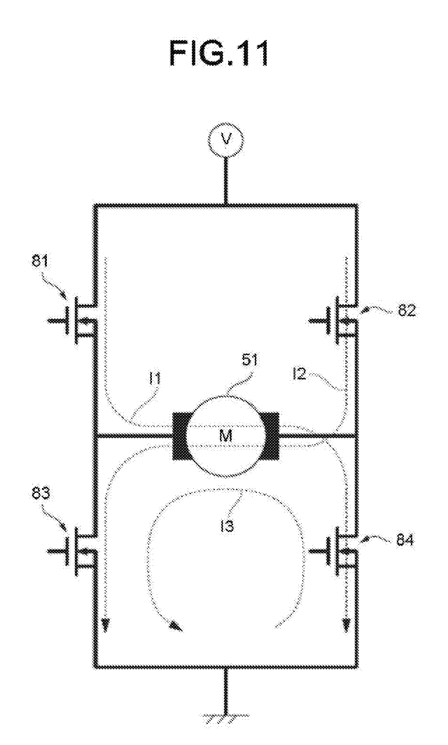

FIG. 11 is a circuit diagram exemplifying the electric connection of the motor 51. FIG. 11 shows a circuit for rotating the motor 51 clockwise or anticlockwise through a FET (field-effect transistor). For the sake of convenience, a gate circuit is not shown in FIG. 11. In FIG. 11, a sign 81 indicates a first FET, a sign 82 indicates a second FET, a sign 83 indicates a third FET and a sign 84 indicates a fourth FET 84.

For example, the first FET 81 and the second FET 82 are P-channel MOSFETs (metal-oxide-semiconductor field-effect transistors). For example, the third FET 83 and the fourth FET 84 are N-channel MOSFETs.

As shown in FIG. 11, if the first FET 81 and the fourth FET 84 are turned on, then a current flows in the direction indicated by an arrow I1. Then, the motor 51 rotates clockwise.

On the other hand, if the second FET 82 and the third FET 83 are turned on, then a current flows in the direction indicated by an arrow 12. In this case, the current flowing into the motor 51 is reverse to that flowing into the motor when the motor rotates clockwise, thus, the motor 51 rotates anticlockwise. It is set that the direction indicated by the arrow I1 is plus and that indicated by the arrow 12 is minus. Hereinafter, the brake generated by the anticlockwise rotation of the motor 51 when a current flows in the direction indicated by the arrow 12 is referred to as ‘anticlockwise rotation brake’.

Further, if the third FET 83 and the fourth FET 84 are turned on, then a current flows in the direction indicated by an arrow 13. Thus, the flow flowing into the motor 51 is reverse to that flowing into the motor when the motor 51 rotates clockwise, consequentially, the motor 51 rotates anticlockwise. Hereinafter, the brake generated from the anticlockwise rotation of the motor 51 when a current flows in the direction indicated by the arrow 13 is referred to as ‘short brake’.

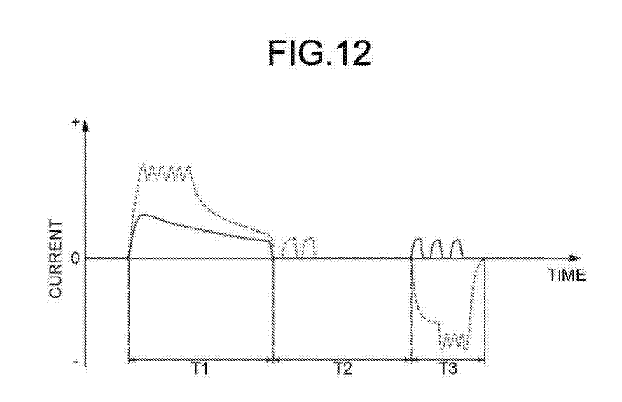

FIG. 12 is a diagram illustrating the effect of the reciprocation assisting section 70 according to an embodiment. In FIG. 12, the horizontal axis indicates time, and the vertical axis indicates current. In FIG. 12, a sign T1 indicates a punching operation start interval, a sign T2 indicates a punching operation interval, and a sign T3 indicates a punching operation stop interval.

An example in which the punching mechanism 40 (refer to FIG. 6) provided with the spring 71 is hereinafter referred to as an ‘embodiment’. A punching mechanism not provided with the spring 71 is hereinafter referred to as a ‘comparative embodiment’. In FIG. 12, the dotted line indicates the graph of the comparative embodiment and the solid line indicates the graph of the embodiment.

A comparative embodiment is described first. As shown in FIG. 12, in the punching operation start interval T1, the current flowing at the plus side, after being increased sharply, is repeatedly increased and decreased while kept increased on the whole to limit the current, that is, chop the current. In the punching operation start interval T1, the increased current, after being chopped, is decreased slowly to 0. The current flowing at the plus side is repeatedly increased and decreased in the punching operation interval T2. In the punching operation stop interval T3, the current flowing at the minus side is increased sharply if a short brake is applied, then the current is repeatedly increased and decreased while kept increased on the whole to limit (chop) the current. In the punching operation stop interval T3, the increased current, after being chopped, is decreased sharply to 0. For example, in the punching operation stop interval T3, a short brake is executed by sharply increasing the current flowing at the minus side. After the short brake is executed, the increased current is chopped to be decreased sharply to generate an anticlockwise rotation brake. The stop position of the punching member 41 is adjusted in the punching operation stop interval T3. For example, a current is regulated according to information from a rotary encoder and a position sensor in the punching operation interval T2 and the punching operation stop interval T3.

An embodiment is described below. In the punching operation start interval T1, the current flowing at the plus side, after being increased sharply, is decreased slowly to 0. Compared with the comparative embodiment, the maximum value of the current in the punching operation start interval T1 is smaller in the embodiment. In the embodiment, the current is not chopped in the punching operation start interval T1, which is different from the comparative embodiment. The current is 0 in the punching operation interval T2. The current flowing at the plus side is repeatedly increased and decreased in the punching operation stop interval T3. The energy lost for the execution of a punching operation is compensated and the stop position of the punching member 41 is adjusted in the punching operation stop interval T3. For example, the current is regulated according to information from a rotary encoder and a position sensor in the punching operation stop interval T3.

Further, it is desired to convey a punched sheet 5 to the discharging section 23 smoothly in the post-processing apparatus 3. To convey a punched sheet 5 smoothly, a conveyance path should be provided rapidly for the sheet 5. To provide a conveyance path for the sheet 5 rapidly, it is needed to lower the punching member 41 quickly to punch a hole in the sheet 5 and then lift and stop the punching member 41 quickly. As a method for speeding up or down the punching member 41 quickly, the motor 51 is rotated clockwise and anticlockwise rapidly. However, if the motor 51 is rotated clockwise and anticlockwise rapidly, then problems may occur, for example, a peak current may be increased. Further, if the motor 51 is rotated anticlockwise rapidly, then the energy generated from the rapid clockwise rotation of the motor 51 is lost, resulting in problems such as energy inefficiency. Particularly, if the motor 51 is repeatedly rotated clockwise and anticlockwise rapidly, then problems such as severe energy inefficiency may occur. As a consequence, more energy is consumed because of the increased peak current and inefficient energy. Further, a brush may be abraded severely, thus shortening the service life of the motor 51.

In accordance with an embodiment, a punching mechanism 40 comprises a punching member 41, a drive section 50 and a reciprocation assisting section 70. The punching member 41 punches a hole in a sheet 5. The drive section 50 causes the punching member 41 to reciprocate with respect to the sheet 5. The reciprocation assisting section 70 stores part of the energy generated from the reciprocation of the punching member 41 and the driving of the drive section 50 during the period the punching member 41 starts reciprocating from an initial position and returns to the initial position. The reciprocation assisting section 70 outputs the stored energy as an auxiliary force used for assisting the punching member 41 in the next reciprocation, thus realizing the following effect: compared with the punching mechanism that is not provided with the reciprocation assisting section 70, the punching mechanism 40 can reuse the energy that should have been lost for the reciprocation of the punching member 41 and the driving of the drive section 50 as an auxiliary force used for assisting the punching member 41 in next reciprocation. Due to the reuse of the energy that should have been lost as an auxiliary force used for assisting the punching member 41 in next reciprocation, it is not needed to rotate the motor 51 clockwise and anticlockwise rapidly to punch a hole in the sheet 5. Thus, the problems such as the increase of a peak current or energy inefficiency are avoided. As a result, the consumption of the energy can be reduced. Further, the severe abrasion of a brush is avoided, thus protecting the motor 51 from being shortened in service life.

For example, even if the motor 51 is rotated gently when a hole is punched in a sheet, the energy stored by the reciprocation assisting section 70 can be used to punch a hole in the sheet 5. Consequentially, a hole is punched in the sheet 5 while energy consumption is lowered.

On the other hand, if the motor 51 is kept rotating while a hole is punched in a sheet 5, the rotational energy of the motor 51 and the energy stored by the reciprocation assisting section 70 can be used to punch a hole in the sheet 5. Consequentially, a hole is punched in the sheet 5 rapidly and effectively while energy consumption is lowered.

For example, even if the motor 51 is kept rotating after a hole is punched in a sheet, the rotational energy of the motor 51 can be reused as an auxiliary force for the execution of a punching operation. Further, even if the motor 51 stops rotating after a hole is punched in a sheet, the rotational inertia force of the rotating member 66 can be reused as an auxiliary force for the execution of a punching operation. If the auxiliary force cannot be reused fully due to the rotational inertia force of the rotating member 66, then assistance is provided through the rotation of the motor 51. Even if a brake (an anticlockwise rotation brake or a short brake) is applied, the spring 71 is compressed while the punching member 41 is lifted towards the upper dead point position P1, thus, the brake is regulated finely. In this way, energy consumption is lowered and the punching member is stopped at the upper dead point position P1.

The punching member 41 reciprocates between the upper dead point position 21 and the lower dead point position P3. The reciprocation assisting section 70 stores part of energy during the period the punching member 41 moves from the lower dead point position P3 to the upper dead point position P1. The reciprocation assisting section 70 outputs the stored energy during the period the punching member 41 moves from the upper dead point position P1 to the lower dead point position P3. Compared with a case in which the reciprocation assisting section 70 stores energy in a state in which the position of the punching member 41 is between the upper dead point position P1 and the lower dead point position P3, the following effect is realized: as a distance needed for the output of the stored energy is fully guaranteed, the output of the stored energy reaches the maximum. Thus, a hole can be punched in a sheet 5 rapidly and effectively.

The reciprocation assisting section 70 outputs the stored energy during the period the punching member 41 moves from the upper dead point position P1 to the punching position Pc, thus realizing the following effect: the use of the stored energy for punching a hole in the sheet 5 is maximized when compared with a case where the stored energy is output during a period the punching member 41 reaches a position (a position under the first side 5a) lower than the punching position Pc. That is, the energy stored by the reciprocation assisting section 70 can be fully used to punch a hole in a sheet 5. Thus, a hole can be punched in the sheet 5 more effectively.

The reciprocation assisting section 70 stores a return assisting force as an auxiliary force during the period the punching member 41 moves from the punching position Pc to the lower dead point position P3, thus realizing the following effect: the punching member 41 finishing punching a hole in a sheet can be returned to the punching position Pc rapidly when compared with a case where the reciprocation assisting section 70 outputs no auxiliary force (no return assisting force is stored) during the period the punching member 41 moves from the punching position Pc to the lower dead point position P3. By making the punching member 41 finishing punching a hole in a sheet return to the punching position Pc rapidly, a conveyance path can be provided rapidly for the sheet 5. Thus, the punched sheet 5 can be conveyed more smoothly.

By arranging a spring 71 on the reciprocation assisting section 70, the following effect is realized: a hole can be punched in a sheet 5 with a simple structure when compared with a case where an assisting mechanism such as an air suspension, a fluid assisting mechanism or an electric assisting mechanism is used as the reciprocation assisting section 70.

The punching member 41 which reciprocates in the perpendicular direction can make use of its deadweight when compared with a punching member 41 reciprocating in a direction intersecting with the perpendicular direction. Thus, a hole can be punched in a sheet 5 more effectively. For example, the storage of a force for assisting in the punching of a hole in a sheet 5 when the punching member 41 is at the upper dead point position P1 maximizes the use of the potential energy of the punching member 41.

The spring 71 can be detached from the punching member 41, thus realizing the following effect: the weight of the spring 71 is not born by the punching member 41, and then the punching member 41 reciprocates smoothly when compared with a case where the spring 71 is connected with the punching member 41.

The post-processing apparatus 3 comprises the foregoing punching mechanism 40, thus reducing the energy consumed to punch a hole in a sheet 5.

Modifications of the embodiment is described below.

The direction in which the punching member 41 reciprocates is not limited to the perpendicular direction. For example, the direction in which the punching member 41 reciprocates may be a direction intersecting with the perpendicular direction.

The spring 71 is not limited to be arranged in such a manner that the spring 71 can be detached from the punching member 41. For example, the spring 71 may be connected with the punching member 41.

The reciprocation assisting section 70 is not necessarily arranged on the punching member 41. For example, the reciprocation assisting section 70 may be arranged on apart of a member (power transmission mechanism 60) located between the drive section 50 and the punching member 41.

The power transmission mechanism 60 is not limited to comprise a first gear 61, a second gear 62, a third gear 63, a suspension member 64, a power conversion section 65, a rotating member 66 and an arm section 67. For example, the power transmission mechanism 60 can be any member that is capable of making the punching member 41 reciprocate with respect to a sheet 5 by means of the rotary drive of the motor 51.

The reciprocation assisting section 70 is not limited to comprise a spring 71. For example, an assisting mechanism such as an air suspension, a fluid assisting mechanism or an electric assisting mechanism can be used as the reciprocation assisting section 70.

The member formed on the support member 42 to guide the reciprocation of the punching member 41 is not limited to the guide wall 42b. A slider for sliding the punching member 41, for example, wheels, may be arranged on the support member 42. The arrangement of the slider on the support member 42 guarantees the smooth reciprocation of the punching member 41.

A modification of an embodiment of the spring 71 is described below.

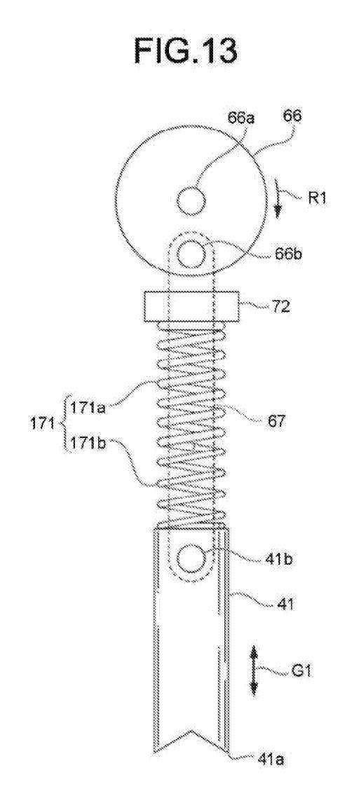

For example, as shown in FIG. 13, a spring 171 may comprise a first spring section 171a and a second spring section 171b. The first spring section 171a has a relatively large spring constant. The second spring section 171b has a relatively small spring constant.

Compared with a spring not provided with the second spring section 171b, the spring 171 provided with the first spring section 171a and the second spring section 171b realizes the following effect: the backlash of the first spring section 171a occurring when a hole is punched in a sheet is absorbed by the second spring section 171b, thus improving punching accuracy. As the second spring section 171b is compressed prior to the first spring section 171a, the punching member 41 finishing punching a hole in a sheet 5 can be moved quickly to be above the sheet 5. By moving the punching member 41 finishing punching a hole in a sheet 5 quickly to be above the sheet 5, a conveyance path is provided rapidly for the sheet 5. Thus, the punched sheet 5 can be conveyed more smoothly.

The first spring section 171a outputs the stored spring force during the period the punching member 41 moves from the upper dead point position P1 to the punching position Pc, thus realizing the following effect: the use of the stored spring force in punching a hole in a sheet 5 is maximized when compared with a case where the first spring section 171a outputs the stored spring force after the punching member 41 reaches a position (a position under the first side 5a) lower than the punching position Pc. Thus, a hole can be punched in the sheet 5 more effectively. Further, even if the use of the spring force of the first spring section 171a in punching a hole in a sheet 5 is maximized, the operation of the punching member 41 finishing punching a hole in the sheet can be slowed down by acting a spring force of the second spring section 171b after the hole is punched in the sheet. Thus, the sound of the operation of the punching member 41 finishing punching a hole in a sheet (the sound of the punching of the sheet 5) is lowered.

The spring 171 is not limited to be provided with sections that are different in spring constant. For example, the spring 171 may include a first spring and a second spring. The first spring has a relatively large spring constant. The second spring has a relatively smaller spring constant.

A modification of an embodiment of the drive section 50 is described below.

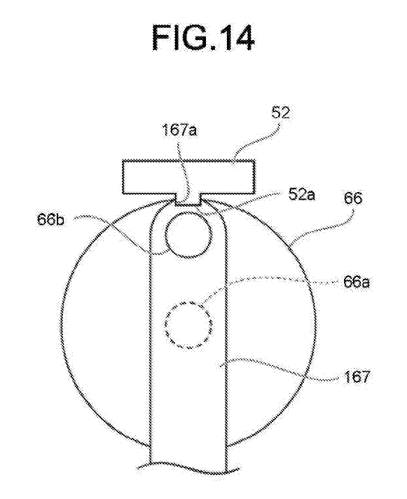

For example, as shown in FIG. 14, in addition to an arm section 167 described in the modification of an embodiment, the modification of an embodiment of the drive section further comprises a regulation member 52. As shown in FIG. 7 and FIG. 14, the regulation member 52 is arranged on the rotating member 66. A protrusion 52a protruding downwards is formed on the regulation member 52. A recess 167a which can be engaged with the protrusion 52a is formed on the upper end portion of the arm section 167. The protrusion 52a is engaged with the recess 167a when the punching member 41 is at the upper dead point position P1. The protrusion 52a and the recess 167a function as a regulation section for stopping the punching member 41 at the upper dead point position P1.

By making the drive section further include the regulation member 52, the reciprocation assisting section 70 can retain the stored auxiliary force when the punching member 41 is at the upper dead point position P1. Thus, the reciprocation assisting section 70 can store the kinetic energy generated from the ascending of the punching member 41 as a force used later for punching a hole in a sheet 5. Further, the reciprocation assisting section 70 can output the stored auxiliary force when the motor 51 starts rotating (the rotating member 66 starts rotating).

The protrusion is not limited to be formed on the regulation member 52. For example, a protrusion protruding upwards may be formed on the upper end of the arm section. If a protrusion is formed on the upper end of the arm section, a recess which can be engaged with the protrusion of the arm section may be formed on the regulation member 52.

In accordance with at least one of the foregoing embodiments, a punching mechanism 40 comprises a punching member 41, a drive section 50 and a reciprocation assisting section 70. The punching member 41 punches a hole in a sheet 5. The drive section 50 causes the punching member 41 to reciprocate with respect to the sheet 5. The reciprocation assisting section 70 stores part of the energy generated from the reciprocation of the punching member 41 and the driving of the drive section 50 during the period the punching member 41 starts reciprocating from an initial position and returns to the initial position. The reciprocation assisting section 70 outputs the stored energy as an auxiliary force used for assisting the punching member 41 in the next reciprocation. Thus, the following effect is realized: compared with the punching mechanism not provided with the reciprocation assisting section 70, the punching mechanism 40 described herein can reuse the energy that should have been lost for the reciprocation of the punching member 41 and the driving of the drive section 50 as an auxiliary force used for assisting the punching member 41 in next reciprocation. As a result, it is not needed to rotate the motor 51 clockwise and anticlockwise rapidly to punch a hole in the sheet 5, consequentially, the problems such as an increased peak current or an energy inefficiency are avoided. Thus, the consumption of the energy is reduced.

While certain embodiments have been described, these embodiments have been presented byway of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A punching mechanism, comprising:
a punching member configured to punch a hole in a sheet;
a drive section configured to cause the punching member to reciprocate with respect to the sheet; and
a reciprocation assisting section configured to store part of energy generated from the reciprocation of the punching member and the driving of the drive section during the period the punching member starts reciprocating from an initial position and returns to the initial position and output the stored energy as an auxiliary force used for assisting the punching member in the next reciprocation.

2. The punching mechanism according to claim 1, wherein
the punching member reciprocates between an upper dead point position which is located on one side of the sheet as the initial position of the punching member and a lower dead point position located on the other side of the sheet; and
the reciprocation assisting section stores part of the energy during the period the punching member returns to the upper dead point position from the lower dead point position and outputs the stored energy during the period the punching member moves from the upper dead point position to the lower dead point position.

3. The punching mechanism according to claim 2, wherein
the reciprocation assisting section outputs the stored energy during the period the punching member moves from the upper dead point position to a punching position connected with a first surface at one side of the sheet.

4. The punching mechanism according to claim 3, wherein
the reciprocation assisting section stores a force for assisting the punching member finishing punching a hole in the sheet in returning to the punching position from the lower dead point position as the auxiliary force during the period the punching member moves from the punching position to the lower dead point position.

5. The punching mechanism according to claim 1, wherein
the reciprocation assisting section comprises a spring.

6. The punching mechanism according to claim 5, wherein
the spring comprises a first spring section with a relatively large spring constant and a second spring section with a relatively small spring constant.

7. The punching mechanism according to claim 2, wherein
the drive section further comprises a regulation member configured to stop the punching member when the punching member is at the upper dead point position.

8. The punching mechanism according to claim 1, wherein
the direction in which the punching member reciprocates is the perpendicular direction.

9. The punching mechanism according to claim 5, wherein
the spring can be detached from the punching member.

10. A sheet processing apparatus, comprising:
a discharging section configured to discharge a sheet conveyed from a conveyance path; and
the punching mechanism of claim 1 for punching a hole in a sheet when the sheet is conveyed towards the discharging section.
